(19) United States
(12) Patent Application Publication
(10) Pub. No.: US 2026/0370040 A1
(43) Pub. Date: Nov. 19, 2026

(54) WIRELESS CHARGING SYSTEM AND OPERATING METHOD THEREOF

(71) Applicant: OmniOn Power Technology GmbH, Baden (CH)

(72) Inventors: Lishen Zhou, Shanghai City (CN); Qin Sun, Shanghai City (CN); Yiming Zhong, Shanghai City (CN)

(21) Appl. No.: 19/319,971

(22) Filed: Sep. 5, 2025

(30) Foreign Application Priority Data
May 13, 2025 (CN) 202510612441.5

(51) Int. Cl. H02J 50/12; H02M 1/00; H02M 1/32; H02M 1/36; H02M 5/458; H02M 7/219

(52) U.S. Cl. CPC H02J 50/12; H02M 1/0009; H02M 1/327; H02M 1/36; H02M 5/458; H02M 7/219

(57) ABSTRACT

The present disclosure provides a wireless charging system including a power transmitting device and a power receiving device. The power receiving device is configured to receive wireless power transmitted from the power transmitting device. The power receiving device includes a receiver coil, a receiver compensation network, a full-bridge rectifier and a control circuit. The full-bridge rectifier is electrically connected to the receiver coil through the receiver compensation network. When a protection mechanism used for the power receiving device is triggered, the control circuit creates a short circuit two bridge arm midpoints of the full-bridge rectifier, in order that a voltage across the two bridge arm midpoints reaches zero. The zero voltage across the two bridge arm midpoints is reflected in an output of the full-bridge inverter included in the power transmitting device to trigger a protection mechanism used for the power transmitting device.

### CROSS-REFERENCE TO RELATED APPLICATION

This application claims priority to China Application Serial Number 202510612441.5, filed May 13, 2025, which is herein incorporated by reference in its entirety.

### BACKGROUND

### Field of Invention

The present invention relates to a wireless charging system and an operating method thereof. More particularly, the present invention relates to wireless charging system based on wireless transfer and an operating method thereof.

### Description of Related Art

For wireless power transfer techniques, a power transmitter and a power receiver are two separate parts, and energy can be wirelessly transferred from the power transmitter to the power receiver. Generally, the power transmitter and the power receiver commute wirelessly to adjust the transmission power and to perform operations, e.g., feedback and protection operations. In such situation, when a protection mechanism used for the power receiver side is triggered, the power receiver usually requests the power transmitter to shut down via wireless communication.

Since a load of a wireless charger is often a battery, a speed in communication between a power transmitter and a power receiver does not need to be very fast. However, the speed in communication may lead to a delay between triggering a protection used for the power receiver side and shutting down the power transmitter. If the power receiver has been shut down due to the protection, while the power transmitter is still operating, it may cause damage to the power receiver. On the other hand, if the wireless communication speed is requested to be as fast as possible, it may increase the cost in wireless communication portions.

Therefore, how to provide a power receiver device to solve the above problems is an important issue in this field.

### SUMMARY

One embodiment of the present disclosure provides a wireless charging system. The wireless charging system includes a power transmitting device and a power receiving device. The power transmitting device includes a transmitter coil, a transmitter compensation network, a full-bridge inverter and a transmitter controller. The full-bridge inverter is electrically connected to the transmitter coil through the transmitter compensation network. The transmitter controller is electrically connected to the full-bridge inverter. The power receiving device is configured to receive wireless power transmitted from the power transmitting device. The power receiving device includes a receiver coil, a receiver compensation network, a full-bridge rectifier and a control circuit. The full-bridge rectifier is electrically connected to the receiver coil through the receiver compensation network. The control circuit is electrically connected to the full-bridge rectifier. The control circuit is configured to control the full-bridge rectifier to operate. When a protection mechanism used for the power receiving device is triggered, the control circuit creates a short circuit between two bridge arm midpoints of the full-bridge rectifier, in order that a voltage across the two bridge arm midpoints reaches zero, the zero voltage across the two bridge arm midpoints is reflected in an output of the full-bridge inverter included in the power transmitting device to trigger a protection mechanism used for the power transmitting device.

In some embodiments, when the two bridge arm midpoints of the full-bridge rectifier are shorted, an output power of the full-bridge rectifier reaches zero, thereby protecting a load.

In some embodiments, the control circuit is configured to control the full-bridge rectifier to operate according to wireless signals transmitted from the power transmitting device, and the zero voltage across the two bridge arm midpoints is used to increase or decrease an output current of the power transmitting device to trigger the protection mechanism used for the power transmitting device.

In some embodiments, if a topology of the transmitter compensation network included in the power transmitting device and the receiver compensation network included in the power receiving device is a zero primary diagonal elements topology or a near-zero primary diagonal elements topology, the output current of the full-bridge inverter decreases, the decrease in the output current is used to trigger a under current protection mechanism used for the power transmitting device. If a topology of the transmitter compensation network included in the power transmitting device and the receiver compensation network included in the power receiving device is a zero secondary diagonal elements topology or a near-zero secondary diagonal elements topology, the output current of the full-bridge inverter increases, the increase in the output current is used to trigger an over current protection mechanism used for the power transmitting device.

In some embodiments, the full-bridge rectifier includes two upper switches and two lower switches. The control circuit is configured to control the two upper switches and the two lower switches. When the protection mechanism used for the power receiving device is triggered, the control circuit is configured to perform the following steps. The two lower switches are set to a conduction state, and the two upper switches are set to an off state; or the two upper switches are set to the conduction state and the two lower switches are set to the off state.

In some embodiments, the full-bridge rectifier includes a switch electrically connected between the two bridge arm midpoints, wherein the control circuit is configured to control the switch, and when the protection mechanism used for the power receiving device is triggered, the control circuit is configured to set the switch to the conduction state.

In some embodiments, the power receiving device further includes a sensing circuit electrically connected to the control circuit. A sensing signal generated by the sensing circuit is used to trigger the protection mechanism used for the power receiving device, and the sensing circuit is an output current sensing circuit, an output voltage sensing circuit, an output power sensing circuit or a temperature sensing circuit.

In some embodiments, the protection mechanism is an over current protection mechanism, an over voltage protection mechanism, an over power protection mechanism or an over temperature protection mechanism.

Another embodiment of the present disclosure provides an operating method for a wireless charging system. The wireless charging system includes a power transmitting device and a power receiving device. The power transmitting device includes a transmitter coil, a transmitter compensation network, a full-bridge inverter and a transmitter controller. The full-bridge inverter is electrically connected to the transmitter coil through the transmitter compensation network. The power receiving device includes a receiver coil, a receiver compensation network, a full-bridge rectifier and a control circuit. The full-bridge rectifier is electrically connected to the receiver coil through the receiver compensation network. The control circuit is electrically connected to the full-bridge rectifier and the sensing circuit. The operating method includes the following steps. The sensing circuit detects a physical quantity from the power receiving device to generate a sensing signal. The control circuit determines that whether the sensing signal triggers a protection mechanism used for the power receiving device. If the sensing signal triggers the protection mechanism used for the power receiving device, the control circuit create a short circuit between two bridge arm midpoints, in order that a voltage across the two bridge arm midpoints reaches zero, and the zero voltage across the two bridge arm midpoints is reflected in an output of the full-bridge inverter included in the power transmitting device, thereby triggering a protection mechanism used for the power transmitting device.

In some embodiments, when the two bridge arm midpoints of the full-bridge rectifier are shorted, an output power of the full-bridge rectifier reaches zero, thereby protecting a load.

Summary, when a protection mechanism used for a power receiving device is triggered, a short circuit between two bridge arm midpoints of the full-bridge rectifier is created to decrease or increase an output current of the full-bridge inverter, and thus there is a significant change that is recognized in the output of the power transmitting device, thereby reducing a delay between triggering the protection used for the power receiving device and triggering the protection used for the power transmitting device.

### BRIEF DESCRIPTION OF THE DRAWINGS

The present disclosure can be more fully understood by reading the following detailed description of the embodiment, with reference made to the accompanying drawings as follows.

FIG. 1 depicts a schematic diagram of a wireless charging system according to one embodiments of the present disclosure.

FIG. 2 depicts a schematic diagram of a wireless power transfer system according to one embodiments of the present disclosure.

FIG. 3 depicts a schematic diagram of a state space model of the wireless power transfer system in FIG. 2 according to one embodiments of the present disclosure.

FIG. 4 depicts a schematic diagram of a wireless power transfer system according to one embodiments of the present disclosure.

FIG. 5 depicts a schematic diagram of a wireless power transfer system according to one embodiments of the present disclosure.

FIG. 6 depicts a flow chart of an operation method according to one embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. Description of the operation does not intend to limit the operation sequence. Any structures resulting from recombination of elements with equivalent effects are within the scope of the present disclosure. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

In the description herein and throughout the claims that follow, unless otherwise defined, all terms have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In the description herein and throughout the claims that follow, the terms “comprise” or “comprising,” “include” or “including,” “have” or “having,” “contain” or “containing” and the like used herein are to be understood to be open-ended, i.e., to mean including but not limited to.

To prevent a power transmitter from continuing to operate after a protection mechanism used for a power receiver was triggered, it is required that the power transmitter recognizes whether the said protection mechanism was triggered. In some situations, when an output of the power receiver, which is provided to the load, changes and reaches an over current threshold or over voltage protection threshold, a voltage across a receiver coil or a current flowing through the receiver coil changes, thereby affecting an output of the power transmitter. However, the output of the power transmitter is also affected by (i) a change in the positions between the receiver coil and the transmitter coil; and/or (ii) the load. For example, if the load does not change and the positions between the receiver coil and the transmitter coil change, a mutual inductance between the receiver coil and the transmitter coil changes, thus the output of the power transmitter changes. In this situation, a change in the output of the power transmitter is within a wide range, and the output of the power transmitter can still be adjusted by controlling feedback loop. In other words, even if a change in the output of the power transmitter is within the aforesaid range, it is unable to determine whether an over current or over voltage occurs in the output of the power receiver. That is, a threshold used for protecting the power transmitter cannot be set in a fixed value in this range.

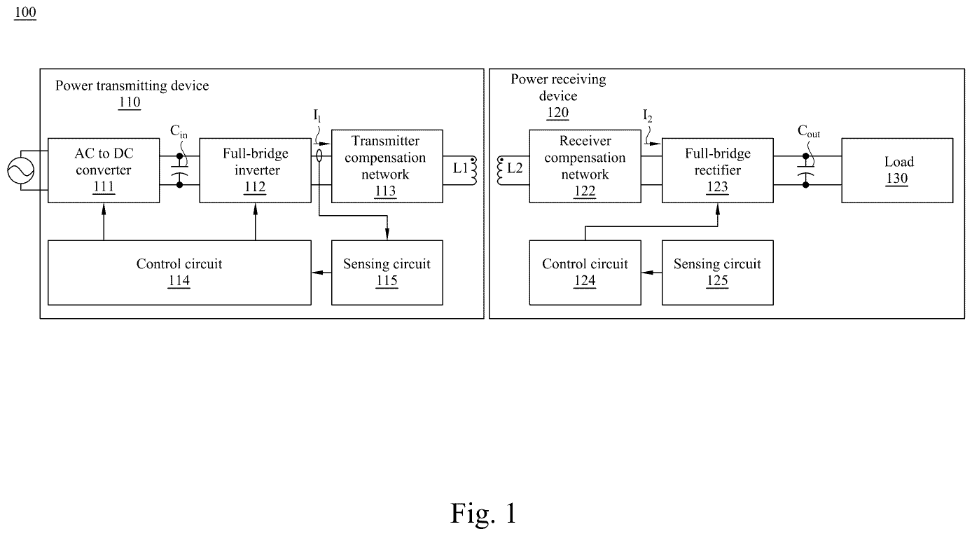

Therefore, the present disclosure provides a wireless charging system and a power receiving device to solve the aforesaid problems. A description is provided with reference to FIG. 1. FIG. 1 depicts a schematic diagram of a wireless charging system 100 according to one embodiments of the present disclosure. As shown in FIG. 1, the wireless charging system 100 includes a power transmitting device 110 and a power receiving device 120. In some embodiments, the power transmitting device 110 is configured to wirelessly transmit power to the power receiving device 120, in order to transmit the electric power to the power receiving device 120 based on wireless power transfer, thereby supplying power to a load 130 included in the power receiving device 120.

In some embodiments, a wireless communication between the power receiving device 120 and the power transmitting device 110 can be established, in order that the control circuit of the power transmitting device 110 can operate according to information of the load 130, thereby supplying corresponding wireless power to the power receiving device 120. In some embodiments, the power transmitting device 110 can be an electronic device, e.g., a wireless charging pad, wireless charging stand, wireless charging base or other power transmitting device. In some embodiments, the power receiving device 120 can be an electronic device, e.g., a mobile device, a wearable device, an electric toothbrush, a power receiving portion in an electric vehicle or other power receiving device.

In some embodiments, the power transmitting device 110 includes an AC-DC converter 111, a full-bridge inverter 112, a transmitter compensation network 113, a control circuit 114, a sensing circuit 115, a capacitor Cin and a transmitter coil L1. In some embodiments, the control circuit 114 is electrically connected to the full-bridge inverter 112 to control operations of the full-bridge inverter 112. In some embodiments, the control circuit 114 is electrically connected to the AC-DC converter 111 to control operations of the AC-DC converter 111. In some embodiments, the control circuit 114 can include a processor, a microprocessor and/or a microcontroller. In some embodiments, the power transmitting device 110 further includes a communication circuit, and thus the control circuit 114 can perform wireless communication by the communication circuit.

In some embodiments, the AC-DC converter 111 converts a AC power to a DC power, and provides a stable DC input to the full-bridge inverter 112 through the capacitor Cin. In some embodiments, the AC-DC converter 111 can be an AC-DC converter with power factor correction function.

In some embodiments, the full-bridge inverter 112 is electrically connected to and output terminal of the AC-DC converter 111 and a capacitor Cin, to converter the DC input to the AC output. In some embodiments, the AC output of the full-bridge inverter 112 is transmitted to the transmitter coil L1 through the transmitter compensation network 113, in order that the transmitter coil L1 induces an electromagnetic field changes over time according to the AC current, thereby transmitting the power to the power receiving device 120.

In some embodiments, the sensing circuit 115 is configured to detect the output current I1 of the full-bridge inverter 112 to generate a sensing signal. In some embodiments, the sensing circuit 115 is a current sensing circuit. In some embodiments, the control circuit 114 determines that whether the protection mechanism used for the power receiving device 120 is triggered according to the sensing signal generated by the sensing circuit 115.

In some embodiments, the power receiving device 120 includes a receiving compensation network 122, a full-bridge rectifier 123, a control circuit 124 and a sensing circuit 125. In some embodiments, the control circuit 124 is electrically connected to the full-bridge rectifier 123 to control operations of the full-bridge rectifier 123. In some embodiments, the control circuit 124 can include a processor, a microprocessor and/or a microcontroller. In some embodiments, the control circuit 124 can include a transmitter controller. In some embodiments, the power receiving device 120 can further include a communication circuit, and the control circuit 124 can communicate with the power transmitting device 110 wirelessly by the communication circuit. In some embodiments, the power receiving device 120 cab send the information of the load 130 to the power transmitting device 110 based on the wireless communication, in order that the power transmitting device 110 supplies the corresponding power according to the information of the load 130.

In some embodiments, there is magnetic coupling between the receiver coil L2 and the transmitter coil L1, the receiver coil L2 induces current according to the electromagnetic field changes over time, the induced current flows to the full-bridge rectifier 123 through the receiving compensation network 122. The full-bridge rectifier 123 performs the rectification on the induced current to output a DC current, and provides a stable DC output by the capacitor Cout to the load 130.

In some embodiments, the sensing circuit 125 is configured to detect a physical quantity from the power receiving device 120 (e.g., an output current, output voltage or output power of the full-bridge rectifier 123 or a temperature at the power receiving device 120) to generate a sensing signal. In some embodiments, the sensing circuit 125 includes an output current sensing circuit, an output voltage the sensing circuit, an output power sensing circuit and/or a temperature sensing circuit. In some embodiments, the control circuit 124 receives a sensing signal generated by the sensing circuit 125 to determine that whether the sensing signal triggers the protection mechanism used for the power receiving device 120. In some embodiments, the protection mechanism(s) used for the power receiving device 120 includes an over current protection mechanism, an over voltage protection mechanism, an over power protection mechanism and/or an over temperature protection mechanism.

In some embodiments, an architecture which includes the full-bridge inverter 112, the transmitter compensation network 113, the transmitter coil L1, the receiver coil L2, the receiving compensation network 122 and the full-bridge rectifier 123 can be considered as a wireless power transfer system. In some embodiments, compensation networks of the wireless power transfer system (e.g., the transmitter compensation network 113 and the receiving compensation network 122) is a zero primary diagonal elements topology or a near-zero primary diagonal elements topology, in order to implement the output of the wireless power transfer system as a constant current source. In other embodiments, compensation networks of the wireless power transfer system is a zero secondary diagonal elements topology or a near-zero secondary diagonal elements topology, in order to implement the output of the wireless power transfer system as a constant voltage source.

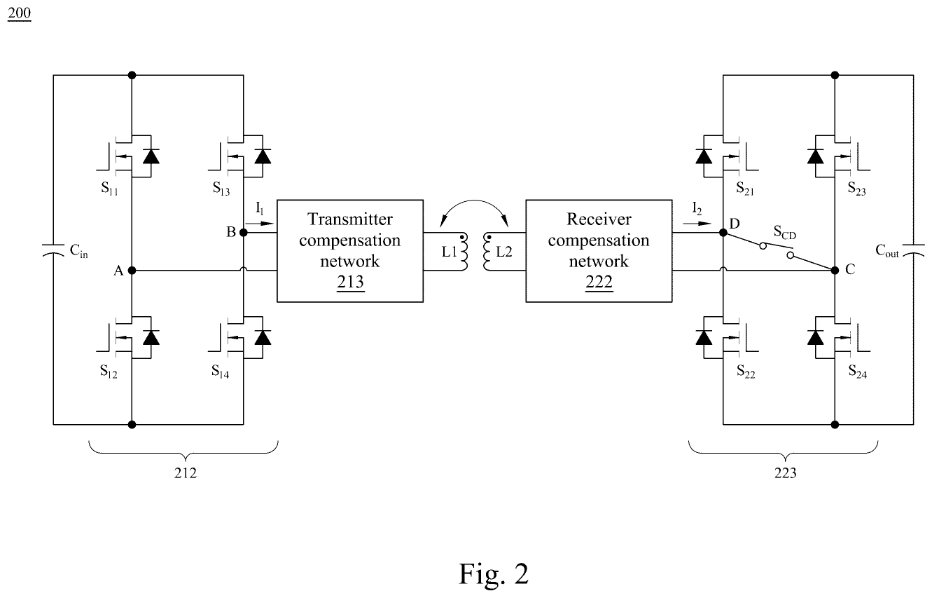

A description is provided with reference to FIG. 2. FIG. 2 depicts a schematic diagram of a wireless power transfer system 200 according to one embodiments of the present disclosure. As shown in FIG. 2, the wireless power transfer system 200 includes a full-bridge inverter 212, a transmitter compensation network 213, a transmitter coil L1, a receiver coil L2, a receiving compensation network 222 and a full-bridge rectifier 223. In some embodiments, the full-bridge inverter 212, the transmitter compensation network 213, the transmitter coil L1, the receiver coil L2, the receiving compensation network 222 and the full-bridge rectifier 223 of the wireless power transfer system 200 in FIG. 2 correspond to the full-bridge inverter 112, the transmitter compensation network 113, the transmitter coil L1, the receiver coil L2, the receiving compensation network 122 and the full-bridge rectifier 123 in FIG. 1.

In some embodiments, the full-bridge inverter 212 includes two bridge arms including upper switches S₁₁ and S₁₃ and the lower switches S₁₂ and S₁₄, where nodes A and B are respectively middle points of the two bridge arms. In some embodiments, a state (e.g. a conduction state or an off state) of each switch (e.g. the upper switches S₁₁ and S₁₃ and the lower switches S₁₂ and S₁₄) are controlled by the control circuit (e.g., the control circuit 114 in FIG. 1). In some embodiments, when the upper switch S₁₁ and the lower switch S₁₄ are in the conduction state and the lower switch S₁₂ and the upper switch S₁₃ are in the off state, the output current I1 of the full-bridge inverter 212 flows in a first direction. In some embodiments, when the upper switch S₁₁ and the lower switch S₁₄ are in the off state and the lower switch S₁₂ and the upper switch S₁₃ are in the conduction state, the output current I₁ of the full-bridge inverter 212 flows in a second direction opposite to the first direction. In some embodiments, the first direction is an anticlockwise direction, and the second direction is a clockwise direction. Therefore, the full-bridge inverter 212 can provide the AC output current I₁.

In some embodiments, the full-bridge rectifier 223 includes two bridge arms including upper switches S₂₁ and S₂₃ and the lower switches S₂₂ and S₂₄, where nodes C and D are respectively middle points of the two bridge arms. In some embodiments, a state (e.g. a conduction state or an off state) of each switch (e.g. the upper switches S₂₁ and S₂₃ and the lower switches S₂₂ and S₂₄) are controlled by the control circuit (e.g., the control circuit 124 in FIG. 1). In some embodiments, when the upper switch S₂₁ and the lower switch S₂₄ are in the conduction state and the lower switch S₂₂ and the upper switch S₂₃ are in the off state, the output current I₂ of the full-bridge rectifier 223 flows in a first direction. In some embodiments, when the upper switch S₂₁ and the lower switch S₂₄ are in the off state and the lower switch S₂₂ and the upper switch S₂₃ are in the conduction state, the output current I₁ of the full-bridge rectifier 223 flows in a second direction opposite to the first direction. Therefore, the full-bridge rectifier 223 can perform the rectification.

In some embodiments, when the protection mechanism used for the power receiving device (e.g. the power receiving device 120 in FIG. 1) is triggered, the control circuit (e.g. the control circuit 124 in FIG. 1) creates a short circuit between two bridge arm midpoints (e.g., the node C and D), in order that a voltage across the nodes C and D of the full-bridge rectifier 223 decreases to zero. Based on compensation networks and magnetic coupling between the receiver coil L2 and the transmitter coil L1, when the voltage across the across the nodes C and D of the full-bridge rectifier 223 decreases to zero, there is a significant change in the output (e.g. the output current I₁) of the full-bridge inverter 212.

In some embodiments, a short circuit between the two bridge arm midpoints (which are the nodes C and D) of the full-bridge rectifier 223 can be created by setting the upper switch S₂₁ and S₂₃ to the conduction state, and setting the lower switch S₂₂ and S₂₄ to the off state. In this embodiments, the switch S_{CD} can be omitted from the full-bridge rectifier 223.

In some embodiments, a short circuit between the two bridge arm midpoints (which are the nodes C and D) of the full-bridge rectifier 223 can be created by setting the lower switch S₂₂ and S₂₄ to the conduction state, and setting the upper switch S₂₁ and S₂₃ to the off state. In this embodiments, the switch S_{CD} can be omitted from the full-bridge rectifier 223.

In some embodiments, the full-bridge rectifier 223 includes a switch ScD connected between the two bridge arm midpoints (which are the nodes C and D) of the full-bridge rectifier 223. In some embodiments, a short circuit between the two bridge arm midpoints (which are the nodes C and D) of the full-bridge rectifier 223 can be created by setting the switch S_{CD} to the conduction state. Meanwhile, the upper switches S₂₁ and S₂₃ and the lower switches S₂₂ and S₂₄ can be set to the off state. In some embodiments, in normal operation, the switch S_{CD} is set to the off state.

In some embodiments, the transmitter compensation network 213 and the receiving compensation network 222 is a zero primary diagonal elements topology or a near-zero primary diagonal elements topology (e.g., S/S topology, P/P topology or other topology) to implement the output of the wireless power transfer system as a constant current source. In the other embodiments, the transmitter compensation network 213 and the receiving compensation network 222 is a zero secondary diagonal elements topology or a near-zero secondary diagonal elements topology (e.g., S/P topology, P/S topology, LC/S topology, LCC/S topology or other topology) to implement the output of the wireless power transfer system as a constant voltage source.

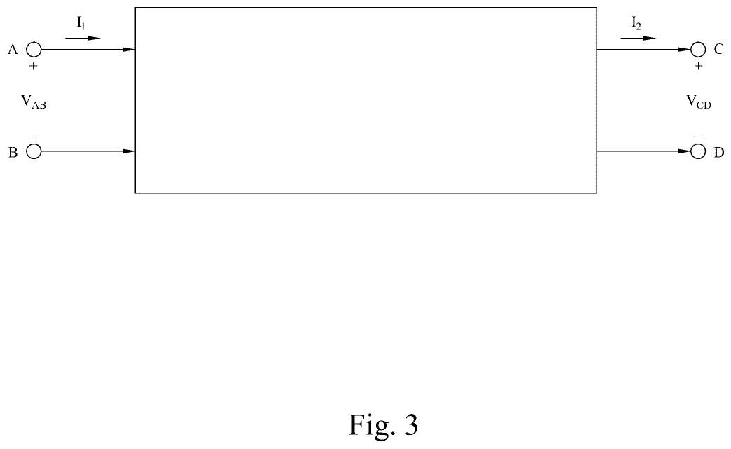

A description is provided with reference to FIG. 3. FIG. 3 depicts a schematic diagram of a state space model of the wireless power transfer system 200 in FIG. 2 according to one embodiments of the present disclosure. As shown in FIG. 3, the voltage V_{AB} refers to a voltage across the nodes A and B (that is, the two bridge arm midpoints of the full-bridge inverter 212), and I₁ refers to the output current of the full-bridge inverter 212. The voltage V_{CD} refers to a voltage across nodes C and D (that is, the two bridge arm midpoints of the full-bridge inverter 223), and I₂ refers to the input current of the full-bridge rectifier 223. In some embodiments, the input and the output of the wireless power transfer system is given by the following matrix.

$$[ \begin{matrix}{V}_{A B} \\ {I}_{1}\end{matrix} ] = A \cdot [ \begin{matrix}{V}_{C D} \\ {I}_{2}\end{matrix} ] = [ \begin{matrix}{a}_{11} & {ja}_{12} \\ {ja}_{21} & {a}_{22}\end{matrix} ] \cdot [ \begin{matrix}{V}_{C D} \\ {I}_{2}\end{matrix} ]$$

In the above function, the term A refers to a matrix, and the terms a₁₁~a₂₂ refer to coefficients.

For the zero primary diagonal elements topology, a₁₁ and a₂₂ are zero, and the input and the output of the wireless power transfer system is given by the following matrix.

$$[ \begin{matrix}{V}_{A B} \\ {I}_{1}\end{matrix} ] = [ \begin{matrix}0 & j {a}_{12} \\ j {a}_{21} & 0\end{matrix} ] [ \begin{matrix}{V}_{C D} \\ {I}_{2}\end{matrix} ]$$

For a near-zero primary diagonal elements topology, a₁₁ and a₂₂ are near-zero, and the input and the output of the wireless power transfer system is given by the following matrix.

$$[ \begin{matrix}{V}_{A B} \\ {I}_{1}\end{matrix} ] = [ \begin{matrix}{a}_{11} & {ja}_{12} \\ {ja}_{21} & {a}_{22}\end{matrix} ] \cdot [ \begin{matrix}{V}_{C D} \\ {I}_{2}\end{matrix} ]$$

In the above function, a₁₁ is far less than a₁₂, and a₂₂ is far less than a₂₁.

For the zero secondary diagonal elements topology, a₁₂ and a₂₁ are zero, and the input and the output of the wireless power transfer system is given by the following matrix.

$$[ \begin{matrix}{V}_{A B} \\ {I}_{1}\end{matrix} ] = [ \begin{matrix}{a}_{11} & 0 \\ 0 & {a}_{22}\end{matrix} ] \cdot [ \begin{matrix}{V}_{C D} \\ {I}_{2}\end{matrix} ]$$

For a near-zero secondary diagonal elements topology, a₁₂ and a₂₁ are near-zero, and the input and the output of the wireless power transfer system is given by the following matrix.

$$[ \begin{matrix}{V}_{A B} \\ {I}_{1}\end{matrix} ] = [ \begin{matrix}{a}_{11} & {ja}_{12} \\ {ja}_{21} & {a}_{22}\end{matrix} ] \cdot [ \begin{matrix}{V}_{C D} \\ {I}_{2}\end{matrix} ]$$

In the above function, a₁₂ is far less than a₁₁, and a₂₁ is far less than a₂₂.

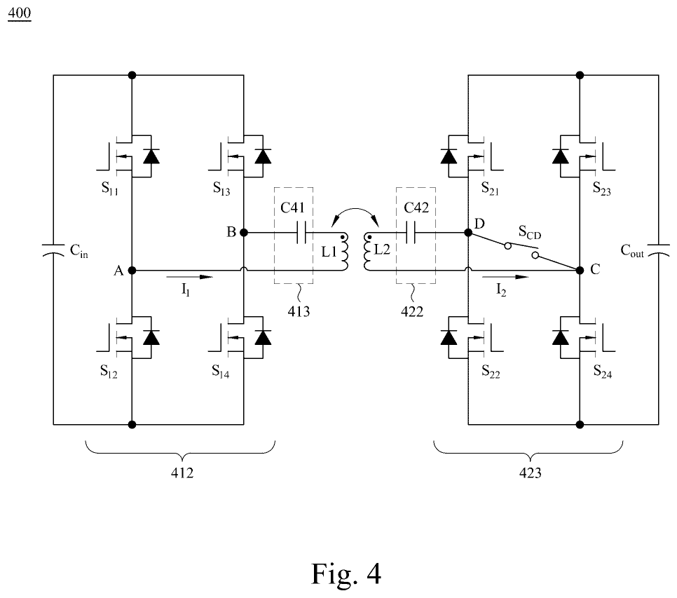

A description is provided with reference to FIG. 4. FIG. 4 depicts a schematic diagram of a wireless power transfer system 400 according to one embodiments of the present disclosure. As shown in FIG. 4, the wireless power transfer system 400 includes a full-bridge inverter 412, a transmitter compensation network 413, a transmitter coil L1, a receiver coil L2, a receiving compensation network 422 and a full-bridge rectifier 423. In some embodiments, the full-bridge inverter 412, the transmitter compensation network 413, the transmitter coil L1, the receiver coil L2, the receiving compensation network 422 and the full-bridge rectifier 423 of the wireless power transfer system 400 in FIG. 4 correspond to the full-bridge inverter 212, the transmitter compensation network 213, the transmitter coil L1, the receiver coil L2, the receiving compensation network 222 and the full-bridge rectifier 223 in FIG. 2.

The network topology of the power transfer system 400 is a zero primary diagonal elements topology or a near-zero primary diagonal elements topology. Specifically, the transmitter compensation network 413 includes a capacitor C41 connected in series with the transmitter coil L1, and the receiving compensation network 422 includes a capacitor C42 connected in series with the receiver coil L2, the network topology of the power transfer system 400 is a S/S topology. In some embodiments, the input and the output of the power transfer system 400 can be given by the following function.

$$[ \begin{matrix}{V}_{A B} \\ {I}_{1}\end{matrix} ] = [ \begin{matrix}0 & - j ω M \\ - j \frac{1}{ω M} & 0\end{matrix} ] \cdot [ \begin{matrix}{V}_{C D} \\ {I}_{2}\end{matrix} ]$$

In the above function, the term M refers to the mutual inductance of the transformer, the term ω refers to frequency of the operation. Based on the above function, functions can be derived as the follow.

$$\{ \begin{matrix}{V}_{A B} = - {I}_{2} \cdot j ω M \\ {I}_{1} = - j \frac{{V}_{C D}}{ω M}\end{matrix}$$

In the above functions, it can be seen that, the output current I₁ of the full-bridge inverter 412 is proportion to a voltage V_{CD} across the nodes C and D (the two bridge arm midpoints of the full-bridge rectifier 423). Therefore, when the two bridge arm midpoints of the full-bridge rectifier 423 are shorted, the voltage V_{CD} significantly decreases, and thus the significant decrease in the output current I₁ of the full-bridge inverter 412 can triggers an undercurrent protection. That is, the zero voltage across the two bridge arm midpoints of the full-bridge rectifier 423 is reflected in an output of the full-bridge inverter 412, thereby triggering the protection mechanism used for the power transmitting device.

In the embodiments of FIG. 4, since the compensation network topology of the wireless power transfer system 400 is a zero primary diagonal elements topology or a near-zero primary diagonal elements topology, the output of the wireless power transfer system 400 is implemented as a constant current source. In this topology, even if the two bridge arm midpoints of the full-bridge rectifier 423 are shorted, the input current I₂ of the full-bridge rectifier 423 depends on the voltage across the nodes A and B (the two bridge arm midpoints of the full-bridge inverter 412) according to the aforesaid functions. Therefore, there is no current stress on the upper switches S₂₁, S₂₃ and the lower switches S₂₂, S₂₄ (and the switch ScD) in the full-bridge rectifier 423.

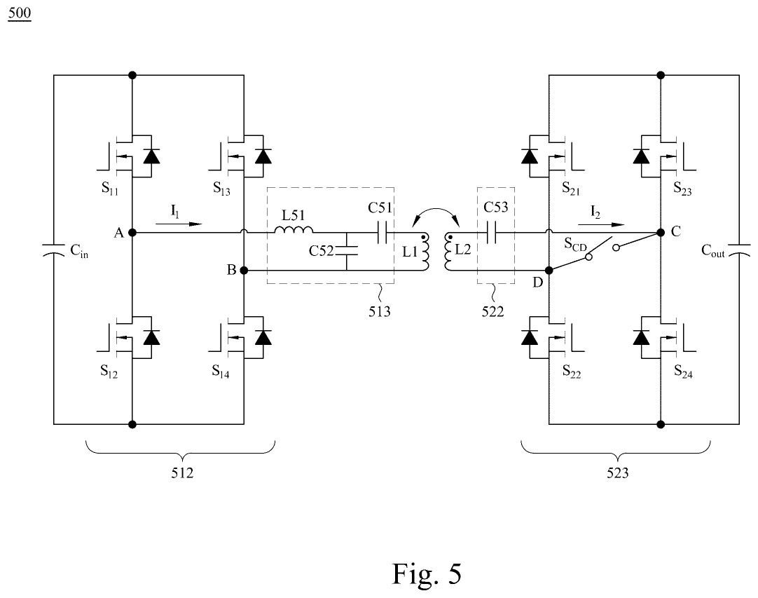

A description is provided with reference to FIG. 5. FIG. 5 depicts a schematic diagram of a wireless power transfer system 500 according to one embodiments of the present disclosure. As shown in FIG. 5, the wireless power transfer system 500 includes a full-bridge inverter 512, a transmitter compensation network 513, a transmitter coil L1, a receiver coil L2, a receiving compensation network 522 and a full-bridge rectifier 523. In some embodiments, the full-bridge inverter 512, the transmitter compensation network 513, the transmitter coil L1, the receiver coil L2, the receiving compensation network 522 and the full-bridge rectifier 523 of the wireless e power transfer system 500 in FIG. 5 correspond to the full-bridge inverter 212, the transmitter compensation network 213, the transmitter coil L1, the receiver coil L2, the receiving compensation network 222 and the full-bridge rectifier 223 in FIG. 2.

The network topology of the power transfer system 500 is a zero secondary diagonal elements topology or a near-zero secondary diagonal elements topology. Specifically, the transmitter compensation network 513 includes an inductor L51, capacitors C51 and C52. The receiving compensation network 522 includes a capacitor C53 connected in series with the receiver coil L2, the network topology of the power transfer system 500 is a LCC/S topology. In some embodiments, the input and the output of the power transfer system 500 can be given by the following function.

$$[ \begin{matrix}{V}_{A B} \\ {I}_{1}\end{matrix} ] = [ \begin{matrix}\frac{{L}_{x}}{M} & 0 \\ 0 & \frac{M}{{L}_{x}}\end{matrix} ] \cdot [ \begin{matrix}{V}_{C D} \\ {I}_{2}\end{matrix} ]$$

In the above function, the term M refers to the mutual inductance of the transformer, the term Lₓ refers to an inductance of the inductor L51. Based on the above function, the functions can be derived as the follow.

$$\{ \begin{matrix}{V}_{A B} = \frac{{L}_{x}}{M} \cdot {V}_{C D} \\ {I}_{1} = \frac{M}{{L}_{x}} {I}_{2}\end{matrix}$$

In the above functions, it can be seen that, the output current I₁ of the full-bridge inverter 512 is proportion to the input current I₂ of the full-bridge rectifier 523. When the two bridge arm midpoints of the full-bridge rectifier 523 are shorted, the input current I₂ of the full-bridge rectifier 523 greatly increases, and the output current I₁ of the full-bridge inverter 512 significantly increases. Therefore, the significant increase in the output current I₁ of the full-bridge inverter 512 can trigger the over current protection. That is, the zero voltage across the two bridge arm midpoints of the full-bridge rectifier 523 is reflected in an output of the full-bridge inverter 512, thereby triggering the protection mechanism used for the power transmitting device.

In the embodiments of FIG. 5, since the compensation network topology of the wireless power transfer system 500 is a zero secondary diagonal elements topology or a near-zero secondary diagonal elements topology, the output of the wireless power transfer system 500 is implemented as a constant voltage source. In this topology, when the two bridge arm midpoints of the full-bridge rectifier 523 are shorted, the input current I₂ of the full-bridge rectifier 523 increases, and there is a need to consider the current stress on the upper switches S₂₁, S₂₃ and the lower switches S₂₂, S₂₄ (and the switch ScD) in the full-bridge rectifier 523.

To be noted that, the compensation network of the present disclosure is for example. Depending on the design of the compensation network, the protection associated to the output current of the full-bridge inverter in the power transmitter side can be equivalent to the voltage or the current protection associated to the other component in the power transmitter side, which is not intend to limit the present disclosure.

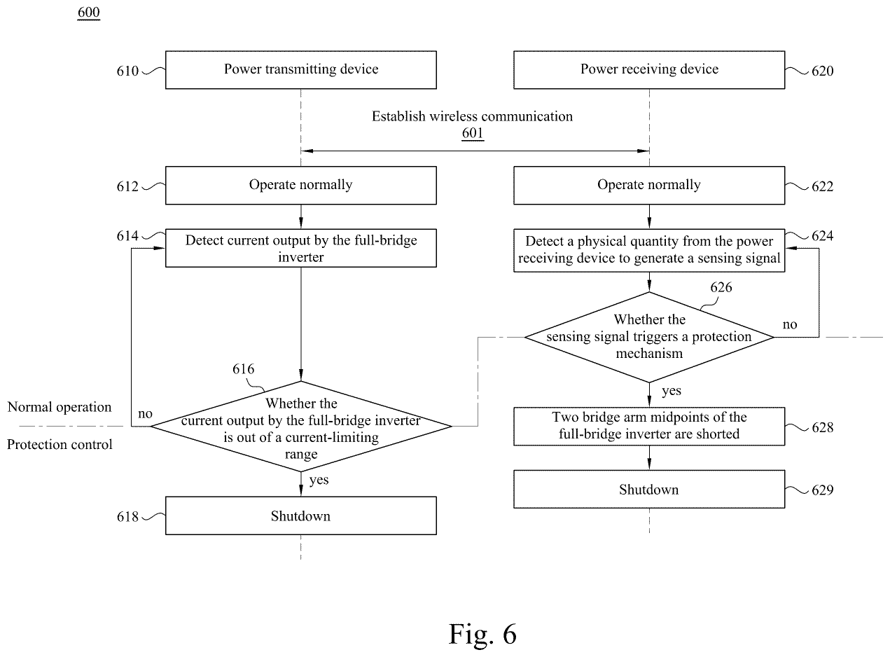

A description is provided with reference to FIG. 6. FIG. 6 depicts a flow chart of an operation method 600 according to one embodiments of the present disclosure. As shown in FIG. 6, the method 600 includes steps 601, 612, 614, 616 618, 622, 624, 626, 628 and 629.

In step 601, the power transmitting device 610 establishes a wireless communication with the power receiving device 620. In some embodiments, each of the power transmitting device 610 and the power receiving device 620 includes a communication circuit, e.g., Bluetooth™ communication circuit, a communication circuit based on cellular network technology or other wireless communication circuit. In some embodiments, the control circuit of the power transmitting device 610 establishes a wireless communication with the power receiving device 620 by the control circuits. In some embodiments, the power receiving device 620 sends the information of the load and the other required parameters to the power transmitting device 610, in order that the power transmitting device 610 operates according to the messages sent by the power receiving device 620. As a result, in steps 612 and 622, the power transmitting device 610 and the power receiving device 620 are in normal operation.

In step 614, the sensing circuit of the power transmitting device 610 detects the current output by the full-bridge inverter.

In step 624, the sensing circuit of the power receiving device 620 detects the physical quantity in the power receiving device 620 to generate the sensing signal. In some embodiments, the said physical quantity can be the output current, the output voltage the output power that the full-bridge rectifier provided to the load and/or the temperature at the power receiving device 620.

In step 626, the control circuit of the power receiving device 620 determines that whether the sensing signal triggers the protection mechanism. In some embodiments, the said protection mechanism can be an over current protection, the over voltage protection, the over power protection and/or the over temperature protection. If YES, step 628 is continued. If No, step 624 is continued.

In step 628, the control circuit of the power receiving device 620 creates a short circuit between the two bridge arm midpoints. As a result, a voltage across the two bridge arm midpoints is zero, and there is a significant change, which can be recognizable, in the output of the full-bridge inverter of the power transmitting device 610.

In step 616, the control circuit of the power transmitting device 610 determines that whether the output current of the full-bridge inverter is out of a current-limiting range. In some embodiments, an upper limit of the current-limiting range can be set based on the over current protection mechanism, and an lower limit of the current-limiting range can be set based on under current protection mechanism. In step 616, if YES, step 618 is continued. If NO, step 614 is continued.

In step 618, the power transmitting device 610 is shutdown.

In step 629, the power receiving device 620 is shutdown.

Summary, in the present disclosure, when the protection mechanism used for the power receiving device is triggered, the two bridge arm midpoints of the full-bridge rectifier are shorted, in order that the voltage across the two bridge arm midpoints of the full-bridge rectifier reaches zero, thus there is a significant change, which can be recognized, in the output of the power transmitting device, in order to reduce a delay between triggering a protection for the power receiving device and shutting down the power transmitting device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless charging system, comprising:
a power transmitting device, comprising:
a transmitter coil;
a transmitter compensation network;
a full-bridge inverter, electrically connected to the transmitter coil through the transmitter compensation network; and
a transmitter controller, electrically connected to the full-bridge inverter; and
a power receiving device, configured to receive wireless power transmitted from the power transmitting device, comprising:
a receiver coil;
a receiver compensation network;
a full-bridge rectifier, electrically connected to the receiver coil through the receiver compensation network; and
a control circuit, configured to control the full-bridge rectifier to operate, and wherein when a protection mechanism used for the power receiving device is triggered, the control circuit creates a short circuit between two bridge arm midpoints of the full-bridge rectifier, in order that a voltage across the two bridge arm midpoints reaches zero, the zero voltage across the two bridge arm midpoints is reflected in an output of the full-bridge inverter included in the power transmitting device to trigger a protection mechanism used for the power transmitting device.

2. The wireless charging system of claim 1, wherein when the two bridge arm midpoints of the full-bridge rectifier are shorted, an output power of the full-bridge rectifier reaches zero, thereby protecting a load.

3. The wireless charging system of claim 2, wherein the control circuit is configured to control the full-bridge rectifier to operate according to wireless signals transmitted from the power transmitting device, and wherein the zero voltage across the two bridge arm midpoints is used to increase or decrease an output current of the power transmitting device to trigger the protection mechanism used for the power transmitting device.

4. The wireless charging system of claim 3, wherein:
if a topology of the transmitter compensation network included in the power transmitting device and the receiver compensation network included in the power receiving device is a zero primary diagonal elements topology or a near-zero primary diagonal elements topology, the output current of the full-bridge inverter decreases, the decrease in the output current is used to trigger a under current protection mechanism used for the power transmitting device; and
if the topology of the transmitter compensation network included in the power transmitting device and the receiver compensation network included in the power receiving device is a zero secondary diagonal elements topology or a near-zero secondary diagonal elements topology, the output current of the full-bridge inverter increases, the increase in the output current is used to trigger an over current protection mechanism used for the power transmitting device.

5. The wireless charging system of claim 1, wherein the full-bridge rectifier comprises two upper switches and two lower switches, wherein the control circuit is configured to control the two upper switches and the two lower switches, wherein when the protection mechanism used for the power receiving device is triggered, the control circuit is configured to:
set the two lower switches to a conduction state, and set the two upper switches to an off state; or
set the two upper switches to the conduction state, and set the two lower switches to the off state.

6. The wireless charging system of claim 1, wherein the full-bridge rectifier comprises a switch electrically connected between the two bridge arm midpoints, wherein the control circuit is configured to control the switch, and wherein when the protection mechanism used for the power receiving device is triggered, the control circuit is configured to set the switch to a conduction state.

7. The wireless charging system of claim 1, wherein the power receiving device further comprises:
a sensing circuit, electrically connected to the control circuit, wherein a sensing signal generated by the sensing circuit is used to trigger the protection mechanism used for the power receiving device, and wherein the sensing circuit is an output current sensing circuit, an output voltage sensing circuit, an output power sensing circuit or a temperature sensing circuit.

8. The wireless charging system of claim 1, wherein the protection mechanism is an over current protection mechanism, an over voltage protection mechanism, an over power protection mechanism or an over temperature protection mechanism.

9. An operating method for a wireless charging system, wherein the wireless charging system comprises a power transmitting device and a power receiving device, wherein the power transmitting device comprises a transmitter coil, a transmitter compensation network, a full-bridge inverter and a transmitter controller, wherein the full-bridge inverter is electrically connected to the transmitter coil through the transmitter compensation network, wherein the power receiving device comprises a receiver coil, a receiver compensation network, a full-bridge rectifier, a control circuit and a sensing circuit, wherein the full-bridge rectifier is electrically connected to the receiver coil through the receiver compensation network, wherein the control circuit is electrically connected to the full-bridge rectifier and the sensing circuit, and wherein the operating method comprises:
detecting a physical quantity, by the sensing circuit, from the power receiving device to generate a sensing signal;
determining that, by the control circuit, whether the sensing signal triggers a protection mechanism used for the power receiving device, and
wherein if the sensing signal triggers the protection mechanism used for the power receiving device, the control circuit create a short circuit between two bridge arm midpoints, in order that a voltage across the two bridge arm midpoints reaches zero, and the zero voltage across the two bridge arm midpoints is reflected in an output of the full-bridge inverter included in the power transmitting device, thereby triggering a protection mechanism used for the power transmitting device.

10. The operating method of claim 9, wherein when the two bridge arm midpoints of the full-bridge rectifier are shorted, an output power of the full-bridge rectifier reaches zero, thereby protecting a load.

11. The operating method of claim 9, wherein:
if a topology of the transmitter compensation network included in the power transmitting device and the receiver compensation network included in the power receiving device is a zero primary diagonal elements topology or a near-zero primary diagonal elements topology, an output current of the full-bridge inverter decreases, the decrease in the output current is used to trigger a under current protection mechanism used for the power transmitting device.

12. The operating method of claim 9, wherein:
if a topology of the transmitter compensation network included in the power transmitting device and the receiver compensation network included in the power receiving device is a zero secondary diagonal elements topology or a near-zero secondary diagonal elements topology, the output current of the full-bridge inverter increases, the increase in the output current is used to trigger an over current protection mechanism used for the power transmitting device.

13. The operating method of claim 9, wherein the full-bridge rectifier comprises two upper switches and two lower switches, and wherein the operating method further comprises:
setting, by the control circuit, the two lower switches to a conduction state, and setting, by the control circuit, the two upper switches to an off state, when the protection mechanism used for the power receiving device is triggered.

14. The operating method of claim 9, wherein the full-bridge rectifier comprises two upper switches and two lower switches, and wherein the operating method further comprises:
setting, by the control circuit, the two upper switches to a conduction state, and setting, by the control circuit, the two lower switches to an off state, when the protection mechanism used for the power receiving device is triggered.

15. The operating method of claim 9, wherein the full-bridge rectifier comprises a switch electrically connected between the two bridge arm midpoints, wherein the operating method further comprises:
setting, by the control circuit, the switch to a conduction state, when the protection mechanism used for the power receiving device is triggered.
